(19) United States
(12) Patent Application Publication
(10) Pub. No.: US 2010/0277748 A1
(43) Pub. Date: Nov. 4, 2010

(54) Method and System for Measuring Relative Positions Of A Specular Reflection Surface

(76) Inventor: Sergey Potapenko, Painted Post, NY (US)

Correspondence Address: CORNING INCORPORATED, SP-TI-3-1, CORNING, NY, 14831, US

(21) Appl. No.: 12/433,257

(22) Filed: Apr. 30, 2009

(51) Int. Cl. G01B 11/14

(52) U.S. Cl. 356/623

(57) ABSTRACT

A method for measuring relative positions of a specular reflective surface of an object along a measurement line is provided. The method includes converging at least one converging light beam at a nominal position on the measurement line and forming a reflected beam from the specular reflection surface. An image of the reflected beam is recorded at a detector plane. A position of the image of the reflected beam on the detector plane is determined and converted to a displacement of the specular reflection surface from the nominal position along the measurement line. A system for carrying out the method is also provided.

### FIELD

The invention relates to measurement of distances to surfaces. In particular, the invention relates to a method and a system for measuring distances to a specular reflection surface by triangulation.

### BACKGROUND

Triangulation meters are used to measure distances to surfaces of objects, particularly in cases where it is undesirable to contact the surfaces of interest with physical devices such as a probe. Such may be the case, for example, for fusion-formed glass sheets with pristine surfaces, where it is desirable to maintain the pristine quality of the surfaces. Such glass surfaces behave as specular surfaces for visible light. In glass production, distance-to-surface measurements may be used, for example, to find the glass surface location in order to bring a point on the glass surface into focus of an inspection or treatment device.

In this disclosure, the term “measurement line” refers to a straight line, associated with a displacement measurement apparatus, along which line the displacement of the measured surface is defined as a relative position of the point where the measurement line crosses the measured surface. The term “measurement direction” refers to the direction of the measurement line. The term “angle tolerance” refers to an ability of a displacement meter to yield a value of displacement along the measurement line, regardless of the inclination (in a certain range of angles) of the measured surface from a nominal orientation. In other words, the absolute measurement error caused by the surface inclination within the certain range of angles does not exceed the measurement error specified for the given apparatus. The terms “nominal position” and “nominal inclination” refer to preferable measured surface location and inclination, respectively. The specific definitions of nominal position and nominal inclination depend on the method of measurement and will be given below.

FIG. 1 illustrates how an optical triangulation meter works in the case of diffuse reflection surfaces (see, for example, Patent Publication No. JP2001050711(A) (Koji, 2001)). An incoming ray 10, from a light source 12 (typically, a laser diode), is projected through a projection lens 14 onto a diffuse reflection surface 16 at position 13. The light, provided by the incoming ray 10, is scattered at spot 11 of the surface 16 in a variety of directions, with a portion of the scattered light, identified as reflected ray 18, passing through an objective lens 20 to the detector 22. The objective lens 20 may form an image of the spot of light 11 at a position 17 on the detector 22. Let 16′ represent surface 16 at position 13′. Then, the incoming ray 10 provides a spot of light 11′ at the surface 16′. The light at spot 11′ is scattered in a variety of directions, with a portion of the scattered light, identified as reflected ray 18′, passing through the objective lens 20 to the detector 22. The objective lens 20 may form an image of the spot of light 11′ at a position 17′ on the detector 22. In general, the position of the image on the detector 22 depends on the position of the surface 16 along the direction of the incoming ray 10. If the surface 16 moves from position 13 to 13′, the position of the corresponding image of the spot light on the detector 22 will move from 17 to 17′. Thus, if the direction of the incoming ray 10 is selected as the measurement direction, correspondence between the position of the image on the detector 22 and the position of the surface 16 along the direction of the incoming ray 10 is well-defined. In the example presented in FIG. 1, the line along incoming ray 10 is the measurement line.

A calibration procedure can be used to establish a conversion function for obtaining the position value of the surface 16 along the measurement line as a function of the image position of the reflected ray 18 on the detector 22. For the diffuse reflection surface 16, the position of the image on the detector 22 is insensitive to the tilt of the surface 16 relative to the incoming ray 10 if the diffusion angle is wide enough to provide sufficient portion of the reflected light to pass through the objective lens 20 and be detected by the detector 22. This means that the incoming ray 10 can be incident on the surface 16 within a relatively wide range of angles between the measurement direction and the surface normal to provide a sufficient portion of the reflected light received by the objective lens 20 to form an image on the detector 22, thus making the system reliable for measuring distances to diffuse reflection surfaces for relatively large ranges of surface inclinations. In this case the nominal surface position can be defined as a location of the measured surface within the working range of location that provides the highest displacement measurement accuracy. The nominal inclination can be defined as the inclination of the measured surface with respect to the displacement meter that maximizes the amount of light received by the detector.

The principle described in Patent Publication No. JP2001050711 (A) (Koji, 2001) and above can be applied to specular reflection surfaces with limitations. Referring to FIG. 2, consider the specular reflection surface 24 at position 25. Let 24′ represent the specular reflection surface 24 at position 25′. Further, let 24″ represent the specular reflection surface 24 at position 25″. By principle, for a specular reflection surface, the value of the angle of reflection of the light with respect to the normal to the surface is equal to the value of the angle of incident light. Using the specular reflection surface 24 at position 25 as an example, the angle β₀ between the incident light 10 and the surface normal 26 is equal to the angle β₁ between the reflected light 28 and the surface normal 26. The normal 26′ to specular reflection surface 24′ is parallel to the normal 26 to specular reflection surface 24. Therefore, the directions of the incoming light 10 and reflected ray 28′ will also make angles β₀ and β₁, respectively, with a normal 26′ to the specular reflection surface 24. To measure distances to the parallel surfaces 24, 24′, a normal to these surfaces (e.g., normal 26 or 26′) can be selected as the measurement direction. In this case the inclination of the surface 24 is the nominal inclination. It is also assumed that the measured surface is essentially flat since the reflected ray does not carry information of what point of the specular surface the reflection occurred. In this case, the position of the surfaces 24, 24′ along the measurement direction can be determined by measuring locations of the points 29, 29′ where the reflected rays 28, 28′ from surfaces 24, 24′, respectively, are received on the detector 22. A conversion function to correlate the position on the detector 22 to the position of the measured surface along the measurement direction should be provided to obtain the result of the measurement, i.e., measured surface displacement.

The conversion function mentioned above is based on selection of the normal to the measured surfaces as the measurement direction 26 and the orientation of surface 24 as the nominal inclination. This conversion function will not yield correct distance measurements along the measurement direction 26 for specular reflection surfaces that are not parallel to the nominal inclination, such as tilted surface 24″ at position 25″. For a surface tilted relative to the position 25, e.g., surface 24″, the position at which the reflected ray, e.g., ray 28″, hits the detector 22 will depend on the tilt of the surface normal relative to the measurement direction as well as on the position along selected measurement direction. Thus, both information about the tilt of the surface normal relative to the measurement direction and the position of the reflected ray on the detector are needed to determine the position of the tilted specular surface along the measurement direction unambiguously. The fundamental reason that makes the triangulation of specular reflection surfaces difficult lies in the fact that specular reflection surfaces cannot be observed directly—only a reflection of the surrounding scene is visible or detectable by a light receiving device. The principle described in Patent Publication No. JP2001050711(A) (Koji, 2001) will allow surface displacement measurements along the measurement direction to be made only for essentially parallel surfaces at nominal inclination or for surfaces that are only slightly tilted relative to nominal inclination within a certain narrow range of surface tilt, where the measurement direction is normal to these surfaces. In other words this method has a narrow angle tolerance.

### SUMMARY

### Technical Problem

The problem to be solved is how to measure distances to a specular surface by triangulation with a relatively wide range of surface tilt angle tolerance.

### Solution to Technical Problem

In a first aspect of the invention, a method of measuring relative positions of a specular reflection surface of an object along a measurement line comprises: (a) converging at least one converging light beam at a nominal position on the measurement line and forming a reflected beam from the specular reflection surface; (b) recording an image of the reflected beam at a detector plane; (c) determining a position of the image of the reflected beam in the detector plane; and (d) converting the position of the image of the reflected beam to a displacement of the specular reflection surface from the nominal position along the measurement line.

In a second aspect, a system for measuring relative positions of a specular reflection surface of an object along a measurement line is provided. The system comprises a light source that generates at least one light beam that converges at a nominal position on the measurement line and forms a reflected beam from the specular reflection surface. The system comprises a light detector that records an image of the reflected beam at a detector plane. The system comprises a data analyzer that receives the record from the light detector, processes and analyzes the record to determine the position of the image of the reflected beam in the detector plane, and converts the position to a displacement of the specular reflection surface from the nominal position along the measurement line.

### ADVANTAGEOUS EFFECTS

The problem of measuring displacement of a specular reflection surface from a nominal position in a given measurement direction has been solved. The result of the measurement within certain accuracy is independent of the tilt of the measured surface for the tilt angles within a certain working tilt range. Such measurement allows focusing of, for example, an inspection or treatment device on the required area of the surface that may be tilted with respect to the optical axis of the inspection or treatment device. The displacement measurements of the specular reflection surface are useful in accurately tracking position of the surface, for example, to enable optimization of various manufacturing processes involving specular reflection surfaces, such as inspection, treatment, finishing or washing processes.

The accuracy of this method is not compromised when the angle between the direction of the incident beam and the measured surface is small, e.g., between 10 and 20 degrees, so the components of the measurement system are not blocking space along the measurement line. Thus, this space may be used for an inspection system or other equipment for manufacturing processes or handling of articles having specular reflection surface.

If the optical displacement meter or the measured object is mounted on a movable platform, then consecutive measurement steps will allow the tilt angle tolerance to be enhanced. Repeating the sequence of measurement steps, including measurement and positioning the measured surface closer to the nominal position, allows achievement of the maximum angle tolerance within the range of the positions of the measured surface.

Multiple converging light beams may be used. The additional information from the multiple beams is processed as in the first aspect and may be used for one or more of the following: enhancing reliability, enhancing accuracy, obtaining the information on the tilt of the surface. For example, in the case of two beams a system of two equations can be solved for the displacement (h) and the measured surface tilt (p) relative to an axis lying in the plane of the measured surface.

### BRIEF DESCRIPTION OF DRAWINGS

FIG. 1 illustrates measurement of the distance to a diffuse reflection surface using a conventional triangulation meter.

FIG. 2 illustrates measurement of the distance to a specular reflection surface using a conventional triangulation meter.

FIG. 3 is a schematic of an optical displacement meter.

FIG. 4 is a schematic of a converging beam light source for use with the meter of FIG. 3.

FIG. 5 is an example of measurement of surface positions using the optical displacement meter of FIG. 3.

FIG. 6 shows an example of an image formed on a detector of the optical displacement sensor of FIG. 3.

FIG. 7 is another example of measurement of surfaces positions using the optical displacement meter of FIG. 3.

FIG. 8A are plots of a typical conversion function for a diffuse triangular meter as described in FIG. 1.

FIG. 8B are plots of a typical conversion function for an optical displacement meter as described in FIG. 3.

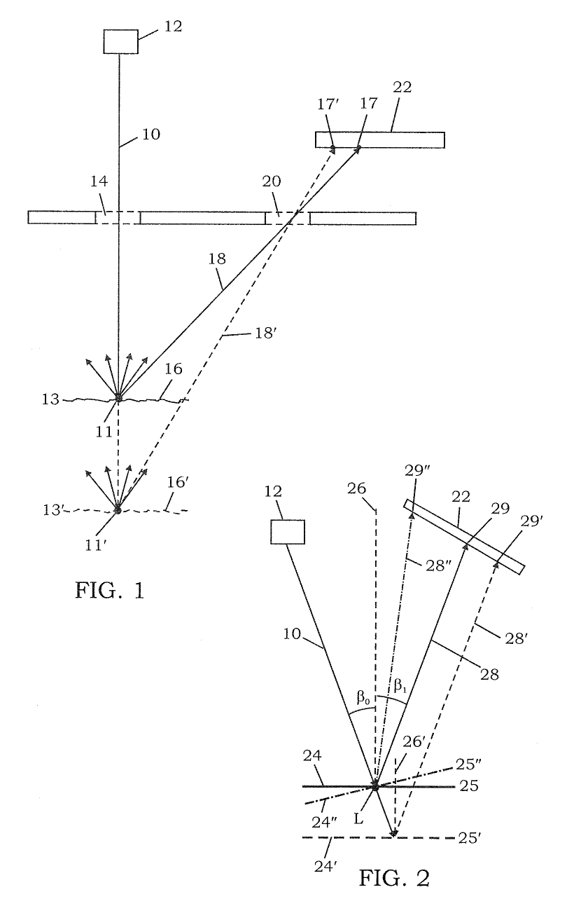

### DESCRIPTION OF EMBODIMENTS

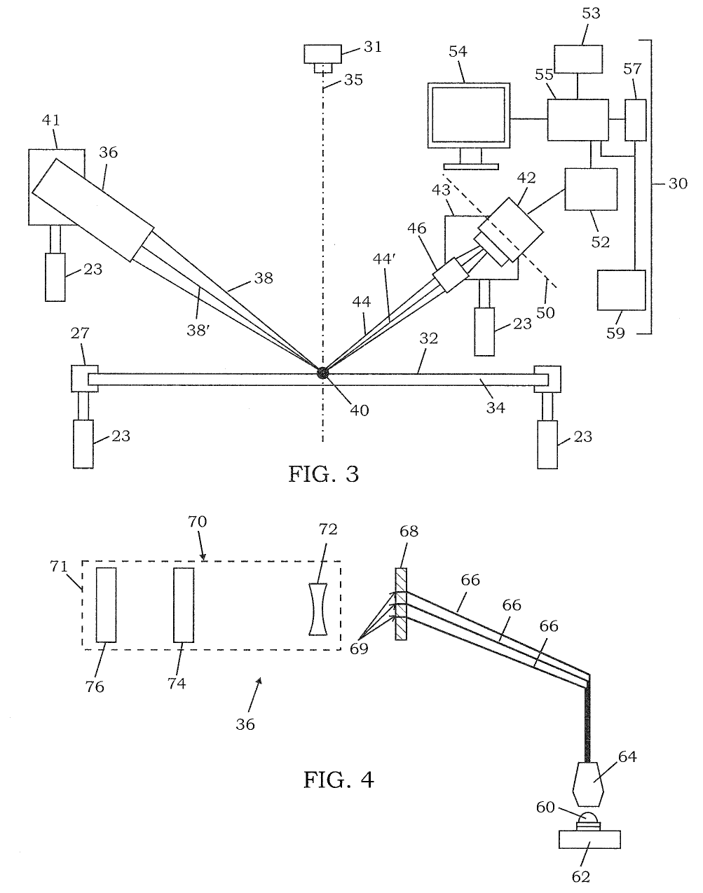

FIG. 3 is a schematic of an optical displacement meter 30 for measuring distances to a surface 32 of an object 34 along a measurement line 35 that intersects the surface 32. Articles 36, 46, 42 52, 54, 55 and 53 in FIG. 3 belong to the displacement meter 30. Article 31 may be a microscope or other equipment, for which the displacement of the measured surface 32 is provided. The optical displacement meter 30 measures distances between the surface 32 and a nominal position 40 along the measurement line 35. The output of the optical displacement meter 30 can be used in at least two different ways.

In the first example, the output can be used to place the surface 32 at a desired location along the measurement direction 35. For example, if the nominal position 40 is selected as the desired location for the surface 32, the optical displacement meter 30 can be used to find out how far the surface 32 is from the desired location, and the output of the optical displacement meter 30 can be used to control how far to move the surface 32 in order to position the surface 32 at the desired location. In general, any known location along the measurement direction can be selected as the desired location provided the distance between the known location and the nominal position 40 is known.

In the second example, the output of the optical displacement meter 30 can be used to measure distance to the surface 32 from an observation point, e.g., observation point 31. As previously mentioned, the optical displacement meter 30 measures the distance between the surface 32 and a nominal position 40. Thus if the distance between the observation point 31 and the nominal position 40 is known, then the distance between the surface 32 and the observation point 31 can be readily calculated using the known distance between the observation point 31 and the nominal position 40 and the output of the optical displacement meter 30.

In a variation of the first example the optical displacement meter 30 can be used to track the movement of the surface 32 and keep the meter 30 and other mechanically-attached meter components at a specified distance from the surface 32. In this case the output from the meter 30 is used as a feedback signal, either analog or digitized, to a motion controller (not shown). The motion controller defines the speed, acceleration and other motion parameters and sends commands to a motion system (not shown) to correct the position as necessary.

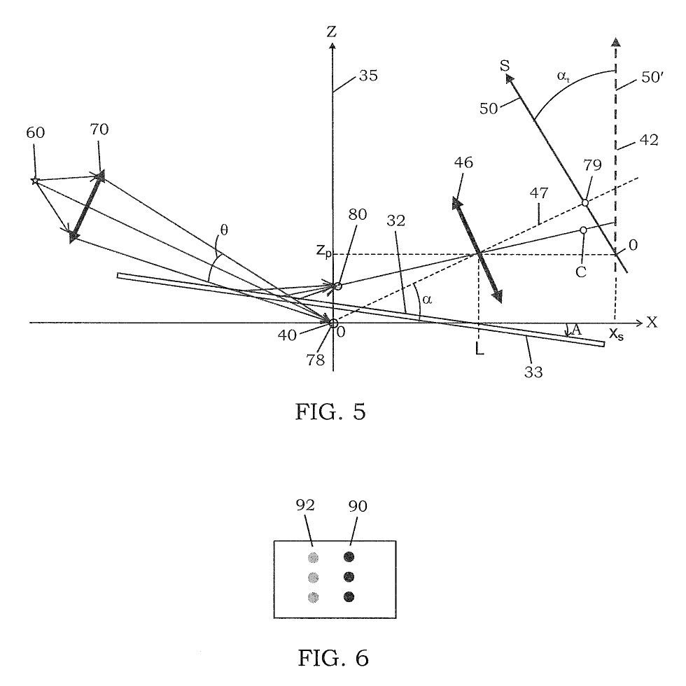

The point 40 where beam 38 converges is the nominal position in this case. The nominal position is preferably selected to be inside the working range of the optical displacement meter 30. The term “working range” refers to an interval of the positions of the measured surface in which the measurement of the position of the surface 32 is possible. In certain embodiments, the nominal position 40 is located in the middle of the working range on the measurement direction 35. The measurement line 35 is the line in the same plane with chief rays 38′ and 44′ of beams 38 and 44, respectively; the angles between 38′ and 35 and between 44′ and 35 are equal. The nominal inclination is defined as the orientation of the measured surface that is perpendicular to the measurement line 35. FIG. 3 shows measured surface 32 in the nominal orientation at the nominal position 40. The optical axis and position of the objective lens 46 and the position of the detector plane 50 are arranged such that the lens 46 focuses the measurement line 35 onto the detector plane 50. Due to this arrangement, as shown in FIG. 5, the optical displacement meter 30 is usable even when the measured surface 32 is tilted relative to the nominal orientation, so that the measurement direction 35 is not normal to the measured surface 32. In general, the error in measurement will be related to the degree of tilt of the measured surface 32 relative to the nominal orientation. In general, the error of the measurement decreases when the measured surface approaches the nominal position.

In certain embodiments, the surface 32 is a specular reflection surface. Herein, the term “specular reflection surface” means that the surface is relatively smooth, mirror-like surface that reflects a single incident ray into a narrow range of outgoing directions. In certain embodiments, the target object 34 may be a sheet of material. In one example, the target object 34 may be a light-transparent sheet of material, e.g., a sheet made of a glass-based material. The glass sheet may be one having uniform thickness and made by a fusion process, such as described, for example, in U.S. Pat. No. 3,682,609 (Dockerty, 1972) and U.S. Pat. No. 3,338,696 (Dockerty, 1964). The edges of object 34 having the surface 32 may be supported in a holder 27, which may be movable relative to the nominal position 40 using any suitable translation mechanism(s) 23.

The optical displacement meter 30 includes at least one light source 36 that provides one or more light beams 38. The light beam(s) 38 converge at the nominal position(s) 40 on the measurement direction 35. The light source 36 may be a converging light source, an example of which will be described below with reference to FIG. 4. The beams may be emitted by a low coherence source, e.g., an LED (light emitting diode) or by an incandescent light source. Alternatively, a laser can be used as the light source.

The optical displacement meter 30 includes a light detector 42 for receiving and recording an image of the reflected light beams 44. An imaging lens 46, e.g., an objective lens or shift and tilt lens, forms an image of the reflection 44 on the detector 42. The detector 42 may be a position-sensing detector or a pixelated array detector, e.g., CCD (charge-coupled device) or CMOS (complementary metal-oxide semiconductor) sensor. In the case of a pixelated array detector, the detector 42 may include a linear array or a two-dimensional array of pixels. The detector 42 receives and records the images essentially at a detector plane, indicated at 50 for illustration purposes.

“Preferable optical arrangement” is defined herein as an arrangement of positions and orientations of the imaging lens 46 and detector 42 such that the image of the measurement line 35 formed by lens 46 lies in the detector plane 50. In other words, to provide the preferable optical arrangement, the imaging lens 46 should focus the measurement line 35 upon the detector plane 50.

In one example, which is a partial case of the defined above preferable optical arrangement, the positions and orientations of the objective lens 46 and the detector 42 are selected such that the optical axis of the objective lens 46 is substantially perpendicular to the measurement direction 35 and the detector plane 50 is substantially parallel to the measurement direction 35. In another example, the positions and orientations of the objective lens 46 and the detector 42 are selected such that the detector plane 50 is tilted with respect to the optical axis of the objective lens 46 and the image of the measurement direction 35 formed by lens 46 lies in the detector plane 50. In the example illustrated in FIG. 3, the axes of the objective lens 46 and the detector plane 50 are inclined relative to the measurement direction 35.

The arrangement of the light source 36, the detector 42, and imaging lens 46 may be such that these components can be moved together as a unit. This may be achieved, for example, by mechanically coupling the imaging lens 46 to the detector 42 and mounting the detector 42 and light source 36 on a suitable common stage or fixture (not shown). Other arrangements are possible. For example, as illustrated in FIG. 3, the light source 36 may be mounted on stage 41 and the detector 42 and imaging lens 46 may be mounted on stage 43. The stages 41 and 43 may be movable relative to the surface 32 using any suitable translation mechanism(s) 23.

The optical displacement meter 30 includes processing electronics 52 for processing the data collected by the detector 42. The configuration of the processing electronics 52 will depend at least in part on the type of detector 42 used. Processing electronics 52 may include one or more of conditioning, amplifying, and digitizing signals received from the detector 42. The optical displacement meter 30 includes a data analyzer 53 that receives data from the processing electronics 52. In some embodiments, the data analyzer 53 includes machine-readable instructions for determining the displacement of the surface 32 from the nominal position 40, as described below. The instructions of the data analyzer 53 may be executed on a CPU 55 having appropriate hardware functionality. Execution of the instructions of the data analyzer 53 may use of one or more program storage devices readable by the CPU or microprocessor 55. The program instructions may be stored on any suitable program storage device, which may take the form of, for example, one or more floppy disks, a CD ROM or other optical disk, a magnetic tape or disk, a read-only memory chip (ROM), and other forms of the kind well-known in the art or subsequently developed. The program of instructions may be “object code,” i.e., in binary form that is executable more-or-less directly by the CPU, in “source code” that requires compilation or interpretation before execution, or in some intermediate form such as partially compiled code. The CPU 55 may store the output of the optical displacement meter 30, e.g., the results of the data analyzer 53, in a suitable storage device 57. The CPU 55 may display the results of the data analyzer 53 and the state of the system on a display device 54. The processing electronic 52 may also include a digital to analog converter to output the results of measurements in a form of an analog signal. The optical displacement meter 30 may include a motion controller 59 that communicates with the storage device 57 or CPU 55. The motion controller 59 may send commands to a motion system, e.g., one or more of translation mechanisms 23, to adjust the position of the measuring components of the optical displacement meter 30 (i.e., light source 36, light detector 42, and imaging lens 46) relative to the surface 32 or the position of the surface 32 relative to the measuring components of the optical displacement meter 30 based on the output of the optical displacement meter 30, which may be obtained from the CPU 55 or the storage device 57.

FIG. 4 shows an example of a converging beam light source that may be used as the light source 36 in FIG. 3. As shown, the converging beam light source 36 includes a light source 60, which in this example may be an LED. The LED 60 may be placed on a heat sink 62. The converging beam light source 36 further includes a coupling lens 64, which couples light from the LED 60 into three (in this particular example) optical fibers 66. In general, light may be coupled from the light source 60 to one or more optical fibers 66. The optical fibers 66 are supported by a suitable fiber holder 68, such as a fixture with holes for receiving the optical fibers 66. Any suitable arrangement of the exit ends 69 of the optical fibers 66 may be used. For example, the exit ends 69 may form a line or a triangle. The exit ends 69 of the optical fibers 66 serve as small light emitters. A condenser lens or lenses 70 is used to create a real image of the ends 69 of the optical fibers 66 at a distance away from the exit end 71 of the condenser 70. The diameter of the light spot produced by the condenser 70 from each of the optical fibers 66 may be smaller than the diameter of the core of the optical fiber 66. In a non-limiting example, the condenser 70 may include a diverging lens 72 and converging lenses 74, 76.

FIG. 5 is an illustration of the working principle of the optical displacement meter 30 of FIG. 3. For ease of calculation, the coordinate system selected such that the measurement line 35 coincides with the Z-axis and the nominal measured surface orientation is parallel with the axis X. The condenser 70 creates a real image of the light source 60 at a position 40, which in FIG. 5 has the (x, z) coordinates of (0, 0). The position 40 is the nominal position of the triangulation meter in this case. This real image of the light source 60 represents a virtual light source 78 at the position 40. The surface 32 to be measured is at some unknown position along the Z-axis. The surface 32 may be displaced form the nominal position 40 along the measurement direction 35 (Z-axis) and may be tilted relative to the nominal orientation by the angle A. The reflection of the virtual light source 78 produced by the surface 32 is shown at 80. The reflection 80 is imaged by the objective lens 46 with a projection point at {L, zₚ} onto point C near or in the detector plane 50. The angle at represents the tilt angle of the detector plane 50 relative to the measurement direction 35. Detector plane 50′ at x=xₛ represents the detector plane 50 when αₜ=0. The positions of the objective lens 46 and the detector 42 are such that the image of the line 35 is focused on the detector plane 50, i.e., according to the preferable optical arrangement defined above. In satisfying the requirement of the preferable optical arrangement positions, the optical axis of the objective lens 46 may or may not coincide with the viewing direction 47. In certain embodiments, the tilt angle αₜ of the detector plane 50 is not equal to zero, and the tilt angle of the optical axis of the objective lens 46 are selected such that the line 35 is focused upon the tilted detector plane 50. In other embodiments, which also satisfy the conditions of the preferable optical arrangement, the tilt angle αₜ of the detector plane 50′ is zero as illustrated at 50′, and the optical axis of the objective lens 46 is selected such that the image of reflection 80 is focused on the detector plane 50′. If a shift lens is used as the imaging lens 46, the optical axis of the shift lens can be selected to be perpendicular to the measurement direction 35, while the detector plane 50′ can be parallel to the measurement direction 35.

If the surface 32 is positioned at the nominal position 40, then the virtual light source 78 lies on the surface 32. The reflection 80 of virtual light source 78 from the surface 32 would coincide with the virtual light source 78 regardless of the tilt of the surface 32. In this case, the image of the virtual point light source 78 will be focused at point 79 (where the optical axis 47 of objective lens 46 intersects the detector plane 50) for all tilt angles A of the surface 32. Thus, when the measured surface is at the nominal location, the position 79 of the image received and recorded at the detector plane 50 will not depend on the tilt angle of the surface 32. The range of allowed amount of the tilt is determined by the angular aperture θ of the converging beam shown in FIG. 5. The requirement on the acceptable value of tilt angle is that an amount of the reflected light collected by the objective lens 46 and received by the detector 42 will be suitable to form an image for reliable image analysis. Increasing the working distances of the light source 60 while keeping the apertures of the imaging objective lens 46 and the condenser 70 the same reduces the tilt tolerance range. To keep the tilt tolerance range constant, the apertures of the light source 60 and objective lens 46 should be increased correspondingly to the working distance to keep the same angular apertures.

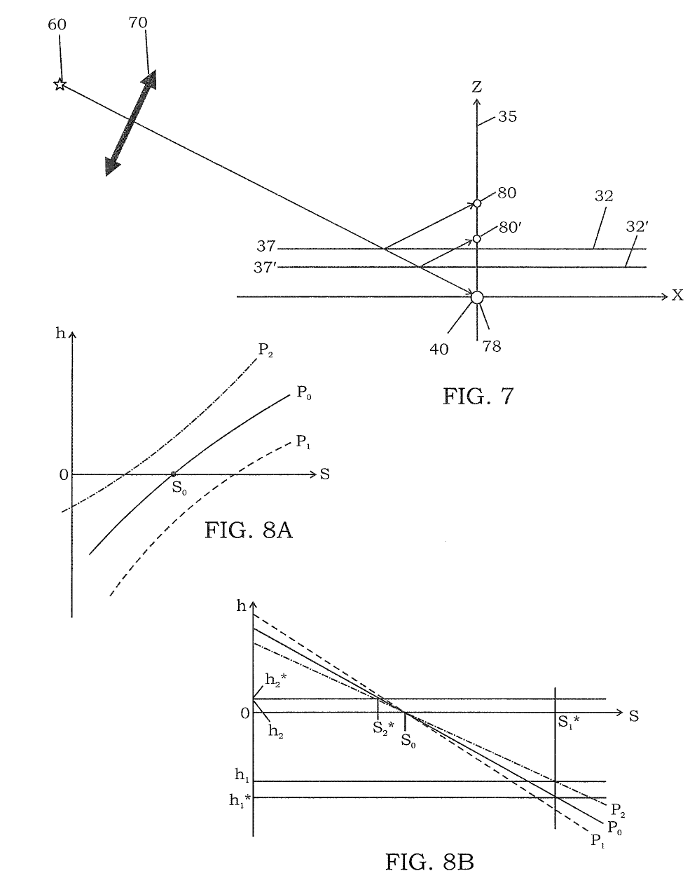

If the surface 32 is positioned at the nominal orientation, i.e., parallel to X-axis, but displaced from the nominal position 40, then the reflection 80 of the virtual light source 78 will be located on the measurement direction 35 for all surface positions. (This is illustrated in simplified FIG. 7 by reflections 80, 80′ from surfaces 32, 32′ at positions 37, 37′ respectively.) Therefore, if the detector plane 50 and objective lens 46 are arranged according to the preferable optical arrangement defined above, the reflection 80 (located on the measurement direction 35) would be imaged onto the detector plane 50. In this case of nominal orientation of the measured surface, the position of the image of the reflection 80 registered by the detector 46 at the detector plane 50 would be a function of the displacement of the surface 32 from the nominal position 40. It will be shown below that the error caused by the surface tilt with respect to the nominal orientation, being minimal at the nominal position, is also small in a range of positions around the nominal position.

The analysis of the image acquired by the detector yields the position (or positions in the case of multiple beams or multiple reflecting surfaces) of the image of the reflection 80 in the detector plane. To obtain a result of the measurement this position needs to be correlated to the displacement of the measured surface with respect to the nominal position. The term “conversion function” is defined herein as a relationship between the position in the detector plane 50 and the actual surface displacement of the measured surface along the measurement line 35 from the nominal position. Generally, the conversion function is not linear since the magnification in the detector plane 50 varies due to the angle at between the optical axis of the objective lens 46 and the measured surface 52 and due to possible optical distortion in the imaging system.

A calibration procedure may be used to establish a conversion function by correlating a plurality of known surface positions along the measurement direction with a corresponding plurality of positions in the image sensed by the detector 42. A calibration function at nominal orientation can be obtained by setting a surface at nominal orientation. The surface is then translated along the measurement direction, which is perpendicular to the surface, while maintaining the surface at nominal orientation in order to obtain a set of image positions on the detector corresponding to the surface positions along the measurement direction. An appropriate interpolating function, e.g., a polynomial interpolation can be used to express the conversion function.

Alternatively, a theoretical expression below for the displacement h(S, p) of the surface 32 as a function of position of the image of the reflection 80 in the detector plane S and the slope p=Tan(A) of surface 32 can be used as the conversion function:

$$h ( S , p ) = L \frac{1 + {p}^{2}}{2} \frac{( {x}_{s} - L ) Tan α - ( Tan α Sin {α}_{t} + Cos {α}_{t} ) S}{( {x}_{s} - L ) - ( Sin {α}_{t} - p Cos {α}_{t} ) S} , \qquad ( 1 )$$

where L is the x-position of the objective lens 46, α is the angle between the surface 32 and the optical axis of the objective lens 46, and αₜ is the angle between the detector plane 50 and the measurement direction 35. Here {xₛ, L Tan α} is the position of the axis S origin in the X-Z coordinate system. For small slope values p<<1, assuming that the surface 32 is close to the nominal position 40, the error in determining the distance between the surface 32 and the nominal position 40 caused by the tilt of the surface 32 from the nominal orientation can be estimated as

$$Δ h = h ( S , p ) - h ( S , 0 ) \approx - \frac{Sin α Cos {α}_{t}}{Cos ( {α}_{t} - α ) - p Sin α Cos {α}_{t}} p h . \qquad ( 2 )$$

It follows from equation (2) that the error decreases when the angle α between the surface 32 and the optical axis of the objective lens 46 decreases. It also follows from equation (2) that the error is proportional to the displacement h of the surface from the nominal position.

The data analyzer (53 in FIG. 3) receives data from the detector 42 in a form of an image in the case of the area detector or in a form of a waveform in the case of the linear array. The data may have been processed by the processing electronics (52 in FIG. 3) prior to being received by the data analyzer. For illustration purposes, a depiction of an image that could be received by the data analyzer is shown in FIG. 6. The measured object was a glass plate with 0.7 mm thickness. Two sets 90, 92 of blobs appear in the image. The blob set 90 corresponds to the reflection from the front specular surface (32 in FIG. 5) of the target object, while the blob set 92 corresponds to the reflection from the back specular surface (33 in FIG. 5) of the target object, if the target object is transparent. Each blob set 90, 92 has three blobs, corresponding to the three beams formed by three optical fibers (66 in FIG. 4). (It should be noted that FIG. 5 shows only rays reflected from the front surface 32. Reflection from the back surface 33 is not shown in FIG. 5.) The blob set 90, corresponding to the front surface, is selected for calculating the measured distance. A polynomial interpolation of the conversion function from pixel coordinates in the image to distance value is used to calculate the measured distance. The interpolation is created using calibration data, which are a series of images acquired at points along the measurement direction with known positions, as described above. The blob set 92 can be used to determine the thickness of the target object if the tilt angle of the target object is known or to determine the tilt angle if the thickness of the target object is known. In this example the multiple beams are used to increase accuracy and reliability of the displacement meter.

FIG. 8A is a graph of a typical conversion function for diffuse triangulation meter when used to measure the displacement of a specular reflection surface. FIG. 8B is a graph of a typical conversion function for an optical displacement meter as described in this invention. In FIGS. 8A and 8B, the lines P₀ are the conversion functions when the measured surface is at nominal slope (e.g., p=0 in equation (1)). Curves P₁ and P₂ show typical dependence of h (the distance between the measured surface and the nominal position) versus S (position of the image on the detector plane) for surfaces tilted at slopes p=p1 and p=p2, respectively. The difference between curves P₁ and P₂ is exaggerated for illustration purposes. For the optical displacement meter described above, P₁ and P₂ curves converge at the nominal position S=S₀, h=₀, as illustrated in FIG. 8B. Note that such convergence does not occur in the typical conversion function for a diffuse triangulation sensor, as illustrated in FIG. 8A. The convergence at the nominal position gives an opportunity to achieve the minimum measurement error at any surface tilt within the working range by repeatedly measuring and reducing the distance between the surface and the nominal position according to the results of the measurements. Let's say that the surface slope is equal to p2 and the actual surface position is equal to h₁. The position of the image on the detector plane will be S₁*. The measured distance of the surface from nominal reported by the optical displacement meter after applying the conversion function to S₁* will be h₁*, thus the absolute value of the measurement error is |h₁−h₁*|. If the optical displacement meter or the surface is moved to approach the nominal position by the measured distance from nominal h₁*, then the actual surface position relative the nominal position will be h₂ and the measured distance of the surface from nominal reported by the meter will be h₂*. The absolute value of the error after completing the second measurement will be |h2−h2*|, which is less than the error |h₁−h₁*| in the first measurement. The absolute value of the measurement error can be reduced further by again moving the optical displacement meter or the surface toward the nominal position by distance h₂*, and then re-measuring the position of the surface. The number of the repetitions required to be within an acceptable absolute value of measurement error depends on the specific system configuration and can be determined for example by comparing the consecutive values of the measured displacement.

As discussed above, the optical displacement meter 30 measures distance between a surface and a nominal position along a measurement line. Measurement of distances may be a single-step process or a multi-step repetitive process. In a single step process, the optical displacement meter 30 measures the distance between the surface and the nominal position, as described above, and outputs the result. The result may be stored for later use by the optical displacement meter 30 or by another device. The result may be used to simply find the location of the surface or to move the surface to a desired location, as previously described. The multi-step process involves a series of single-step processes interspersed by translation of either the nominal position or the surface. The motion system should be capable of the translating by the specified distance. The position of the surface relative to the nominal position can be changed by translating the optical displacement meter, or the components of the optical displacement meter responsible for emitting light and imaging reflection of the light. In a two-step process, for example, the optical displacement meter is used to measure the distance between the surface and the nominal position. Then, the surface or the nominal position is moved by an amount equal to the output of the optical displacement meter. This would place the surface at or closer to the nominal position than the initial position. Then, the optical displacement is used to repeat the previous step. The advantage of this repetitive measurement process is that the result of the measurement improves as the surface moves nearer to the nominal position. If the repetitive measurement process is used to locate a surface, then the surface may be held fixed while the nominal position is moved towards the surface. If the multi-step process is used to position the surface at a desired location, then the displacement meter should be disposed and held fixed such that its nominal position is near the desired surface position. The surface should be moved towards the nominal position according to the result of the measurement taken in the previous step. In either case, a position encoder, a stepper motor or other suitable device can be used to keep track of translation of the nominal position, and the output of the position encoder can be used to adjust the final result of the process. In this manner, a sheet inspection or treatment device may be accurately positioned at an optimal operating distance from the glass surface (or the glass may be positioned relative the device), within a predetermined accuracy.

### INDUSTRIAL APPLICABILITY

The configuration of the optical displacement meter described above is such that it can be used with other devices such as a microscope to locate a point on a surface. In a practical application, the microscope could be disposed along the measurement direction while the optical displacement meter takes the distance measurement along the measurement direction for a surface being viewed through the microscope. The distance measured by the optical displacement meter can be used by the microscope, or other similar device, to bring a specific location on the measured surface into focus, e.g., for inspection purposes, or to place the surface at a specific location, or to maintain a surface at a certain distance. The optical displacement meter is useful for noncontact inspection of specular surfaces, such as surfaces of glass sheets formed by a fusion process.

### REFERENCE SIGNS LIST

10: incoming ray; 12: light source; 13: position; 13′: position; 14: projection lens; 16: diffuse reflection surface; 18: reflected ray; 18′: reflected ray; 20: objective lens; 23: translation mechanism; 22 detector; 24: specular reflection surface; 25: position; 25′: position; 25″: position; 27: holder; 30: optical displacement meter; 31: observation point; 32 surface; 32′: surface; 33: back surface; 34: target object; 35: measurement direction; 36: light source; 37: position; 37′: position; 38 light beam; 40: nominal position; 41: stage; 42: light detector; 43: stage; 44: reflection; 46: imaging lens; 50: detector plane; 52: processing electronics; 53: data analyzer; 54: display device; 55: CPU; 57: storage device; 59: motion controller; 60: light source; 62: heat sink; 64: coupling lens; 66: optical fiber; 68: fiber holder; 69: fiber end; 70: condenser; 72: diverging lens; 74, 76: converging lens; 79: focus point; 80: reflection; 80′: reflection; 90, 92: blob set.

What is claimed is:

1. A method for measuring relative positions of a specular reflection surface of an object along a measurement line, comprising:
(a) converging at least one converging light beam at a nominal position on the measurement line and forming a reflected beam from the specular reflection surface;
(b) recording an image of the reflected beam at a detector plane;
(c) determining a position of the image of the reflected beam in the detector plane; and
(d) converting the position of the image of the reflected beam to a displacement of the specular reflection surface from the nominal position along the measurement line.

2. The method in claim 1, wherein multiple converging light beams are converged at the nominal position in step (a).

3. The method in claim 1, further comprising:
(e) moving the specular reflection surface or the nominal position by an amount based on the displacement obtained in step (d); and
(f) repeating steps (a)-(d).

4. The method in claim 1, further comprising:
(e) moving the specular reflection surface or the nominal position by an amount based on the displacement obtained in step (d);
(f) determining an absolute error in measurement of the displacement; and
(g) repeating steps (a)-(f) until the absolute error is at or below a predetermined value.

5. The method of claim 1, further comprising:
(e) storing or outputting the displacement as a result of the method.

6. The method of claim 1, wherein the object has multiple specular reflection surfaces, a reflected beam is formed from each of the multiple specular reflection surfaces in step (a), and the image of the reflected beams are recorded at the detector plane in step (b).

7. The method of claim 1, further comprising focusing the measurement line upon the detector plane prior to or simultaneously with step (b).

8. The method of claim 1, wherein step (d) comprises using a plurality of known surface positions along the measurement line and a corresponding plurality of image positions on the detector plane to calibrate a conversion function between displacement of the specular reflection surface along the measurement line and the position of the image of the reflected beam in the detector plane.

9. A system for measuring relative positions of a specular reflection surface of an object along a measurement line, comprising:
a light source that generates at least one light beam that converges at a nominal position on the measurement line and forms a reflected beam from the specular reflection surface;
a light detector that records an image of the reflected beam at a detector plane; and
a data analyzer that receives the record from the light detector, processes and analyzes the record to determine the position of the image of the reflected beam in the detector plane, and converts the position to a displacement of the specular reflection surface from the nominal position along the measurement line.

10. The system of claim 9, further comprising an imaging lens, wherein the imaging lens and the detector plane are positioned and oriented such that the imaging lens focuses the measurement line upon the detector plane.

11. The system of claim 10, wherein the imaging lens is an objective lens or a shift and tilt lens.

12. The system of claim 9, wherein the data analyzer converts the position to the displacement using a plurality of known surface positions along the measurement line and a corresponding plurality of image positions on the detector plane to calibrate a conversion function between displacement of the specular reflective surface along the measurement line and the position of the image of the reflected beam on the detector plane.
